(19) United States
(12) Patent Application Publication
(10) Pub. No.: US 2013/0148017 A1
(43) Pub. Date: Jun. 13, 2013

(54) VISUAL PRESENTER

(71) Applicant: Elmo Co., Ltd., Nagoya-shi (JP)

(72) Inventors: Hiroyuki FURUSAWA, Nagoya-shi (JP); Yusuke DOHI, Nagoya-shi (JP); Hiroshi MAMEDA, Nagoya-shi (JP)

(73) Assignee: ELMO CO., LTD., Nagoya-shi (JP)

(21) Appl. No.: 13/685,840

(22) Filed: Nov. 27, 2012

(30) Foreign Application Priority Data
Dec. 7, 2011 (JP) 2011-267740

(51) Int. Cl. H04N 5/225

(52) U.S. Cl. CPC H04N 5/2252
USPC 348/376

(57) ABSTRACT

A visual presenter includes a base, first and second column supports and a video camera head. The base has an upper surface formed with an accommodation recess located substantially at a central part of the upper surface. When the column supports and the camera head are in respective accommodation positions, the second column support and the video camera head are configured to lie along a front surface of the first column support. The column supports and the video camera head are configured to be accommodated in the accommodation recess. Upper surfaces of the second column support and the vide camera head are substantially co-planar with an upper surface of the base.

### CROSS-REFERENCE TO RELATED APPLICATIONS

This application is based upon and claims the benefit of priority from the prior Japanese Patent Application No. 2011-267740, filed on Dec. 7, 2011, the entire contents of which are incorporated herein by reference.

### BACKGROUND

1. Technical Field

The present disclosure relates to a visual presenter which includes a base, a column support mounted on the base and a video camera head mounted on a distal end of the column support and in which a material such as document, model or the like is imaged by the video camera head and an obtained image is supplied to a monitor or projected by a video projector onto a screen.

2. Related Art

Japanese Patent Application Publication No. JP-A-2011-119954 discloses a visual presenter of the above-described type. The disclosed visual presenter 100 includes a flat box-shaped base 101, a first column support 102, a second column support 103 and a video camera head 104 mounted to a distal end of the second column support 103, as shown in FIGS. 18 and 19 of the present application.

In the visual presenter disclosed in the above-mentioned publication, the first column support 102 is mounted on a first shaft further mounted on a left side front end of the base 101 so that the first column support 102 is pivotable in a front-back direction between an accommodation position where the first column support overlaps the left side of the base and a use position where the first column support 102 is leaned forward from the base at a predetermined rising angle. The second column support 103 is mounted on a second shaft further mounted on a distal end of the first column support 102 so that the second column support 103 is pivotable in the front-back direction between an accommodation position where the second column support overlaps the side of the first column support 102 and a use position where the second column support 103 extends from the distal end of the first column support 102 in the same direction as the first column support 102.

The video camera head 104 includes a camera base 107 and a lens 108. The camera base 107 is mounted on a third shaft 109 further mounted on a distal end of the second column support 103 so that the camera base 107 is pivotable in the front-back direction. The lens 108 is mounted on a fourth shaft 110 further mounted on the camera base 107 so that the lens 108 is pivotable in a right-left direction.

In use of the above-described visual presenter, the first column 102 support 102 is leaned from the front end of the left side of the base 101 at the predetermined rising angle. The second column support 103 is then extended from the distal end of the first column support 102 in the same direction as the first column support 102. The video camera head 104 is moved so as to be substantially parallel to a base installation surface on which the base 101 is located, so that the lens 108 is directed to the material placed in an area located in front of the base 101 located on the base installation surface.

When the visual presenter 100 is not in use, the first column support 102 is caused to overlap the left side surface of the base 101 and the second column support 103 is caused to overlap the side of the first column support 102, so that the vide camera head 104 is set in line with the front surface of the base 101 so as to be located in front of the front surface of the base 101.

According to the above-described construction, an entire visual presenter 100 can be folded into a compact book shape when not in use. Accordingly, the visual present 100 can easily be stored and carried.

However, since the vide camera head 104 is set in line with the front surface of the base 101 when the visual presenter 100 is not in use, the dimension of the entire visual presenter 100 in the front-back direction is increased such that the entire visual presenter 100 becomes bulky.

Furthermore, the first column support 102 is mounted on the first shaft 105 further mounted on the left side of the base 101. Accordingly, when the first column support 102 is caused to stand from the base 101, the load of the first and second column supports 102,103 and the video camera head 104 is biased toward the left part of the base 101. Still furthermore, one end of the first shaft 105 is a free end though the other end is fixed to the base 101. Accordingly, the first column support 102 raised in use of the visual present 100 becomes unstable. This would cause the video camera head 104 to easily swing in the right-left direction of the base 101 during imaging, with the possibility that an obtained image may also be swung.

### SUMMARY

An object of the present disclosure is to provide a visual presenter which can be folded compactly when not in use and can prevent the swing of obtained image due to an unstable state of the column support raised in use.

The disclosure provides a visual presenter comprising a base, a column support which stands on the base so as to be pivotable, and a video camera head mounted on a distal end of the column support, the video camera head being located substantially right above a material placed on a base installation surface so that the material is imaged by the video camera head. In the visual presenter, the column support includes a first column support and a second column support. The base has an upper surface formed with an accommodation recess which is located substantially at a central part of the upper surface and extends in a front-back direction of the base. The accommodation recess has a front end with two side surfaces between which a first shaft is disposed, the first shaft having two ends fixed to the base. The first column support is mounted on the first shaft so as to be pivotable in the front-back direction between an accommodation position where the first column support lies in the accommodation recess and a use position where the first column support is raised from the accommodation recess to be leaned forward from a front surface of the base. The second column support has a proximal end mounted on a distal end of the first column support so that the second column support is pivotable in the front-back direction between an accommodation position where the second column support lies along a front of the first column support and a use position where the second column support extends from the first column support. The video camera head is mounted on a third shaft further mounted on a distal end of the second column support so that the video camera head is pivotable in the front-back direction between an accommodation position where the video camera head extends in the same direction as the second column support and a use position where the lens projects forward from the distal end of the second column support. When the first and second column supports and the camera head are in the respective accommodation positions, the second column support and the video camera head are configured to lie along the front surface of the first column support. The first and second column supports and the video camera head are configured to be accommodated in the accommodation recess. The second column support and the video camera head have respective upper surfaces that are substantially co-planar with an upper surface of the base.

When the material placed on the base installation surface is imaged by the above-described visual presenter, the first column support is raised from the accommodation recess and leaned forward from the front surface of the base. The second column support is extended from the distal end of the first column support. The lens is projected forward from the distal end of the second column support and directed to the material. On the other hand, when the visual presenter is not in use, the second column support and the video camera head are laid in front of the first column support. The first and second column supports and the video camera head are accommodated in the accommodation recess.

According to the above-described construction, the first and second column supports and the video camera head can be accommodated in the accommodation recess formed in substantially the central part of the upper surface of the base. Thus, since the video camera head does not protrude out of the base, the visual presenter can be folded compactly. Furthermore, the first column support is mounted on the front end of the accommodation recess formed in the central part of the base. Accordingly, when the first column support has been raised, the load of the first and second column supports, the video camera head and the like can be prevented from being biased toward the left or right part of the base. Still furthermore, the first shaft supporting the first column support is disposed between the side surfaces of the front end of the accommodation recess, whereby both ends of the first shaft are fixed to the base. Consequently, the obtained image can be prevented from swing due to instability of the first column support raised during use.

In an embodiment, the video camera head is divided into a camera base and a lens and the camera base is mounted on the third shaft further mounted on the distal end of the second column support. The visual presenter further comprises a fourth shaft on which the lens is mounted and which is further mounted on the camera base so that the lens is pivotable in a right-left direction; a first retaining unit provided on the first shaft to retain the first column support at any pivot angle within a predetermined range relative to the base; a second retaining unit provided on the second shaft to retain the second column support at any pivot angle within a predetermined range relative to the first column support; a third retaining unit provided on the third shaft to retain the video camera head at any pivot angle within a predetermined range relative to the second column support; and a fourth retaining unit provided on the fourth shaft to retain the lens at any pivot angle within a predetermined range relative to the camera base.

The visual presenter can obtain an image from the material placed in front of the base, at front left or right, at the base installation surface in the rear of the base, at the back of the base, at the rear right or left of the base or the like as well as on the base installation surface in front of the base.

### BRIEF DESCRIPTION OF THE DRAWINGS

In the accompanying drawings:

FIG. 1 is a perspective view of the visual presenter according to one embodiment, showing a first manner of use;

FIG. 2 is an exploded perspective view of the first and second column supports of the visual presenter;

FIG. 3 is an exploded perspective view of a first column support of the visual presenter;

FIG. 4 is an exploded perspective view of a first shaft support construction of the visual presenter;

FIG. 5 is an exploded perspective view of a second shaft support construction of the visual presenter;

FIG. 6 is an exploded perspective view of a shaft member of the second shaft support construction;

FIG. 7 is an exploded perspective view of third and fourth shaft support constructions of the visual presenter;

FIG. 8 is an exploded perspective view of the third shaft support construction;

FIG. 9 is an exploded perspective view of a shaft member of the third shaft support construction;

FIG. 10 is an exploded perspective view of the fourth shaft support construction;

FIG. 11 is a perspective view of the visual presenter, showing a second manner of use;

FIG. 12 is a perspective view of the visual presenter, showing a third manner of use;

FIG. 13 is a perspective view of the visual presenter, showing a fourth manner of use;

FIG. 14 is a perspective view of the visual presenter, showing a fifth manner of use;

FIG. 15 is a perspective view of the visual presenter, showing a sixth manner of use;

FIG. 16 is a perspective view of the visual presenter, showing the column supports and the video camera head being folded;

FIG. 17 is a perspective view of the visual presenter, showing the column supports and the video camera head which have been folded;

FIG. 18 is a perspective view of a conventional visual presenter, showing a manner of use thereof; and

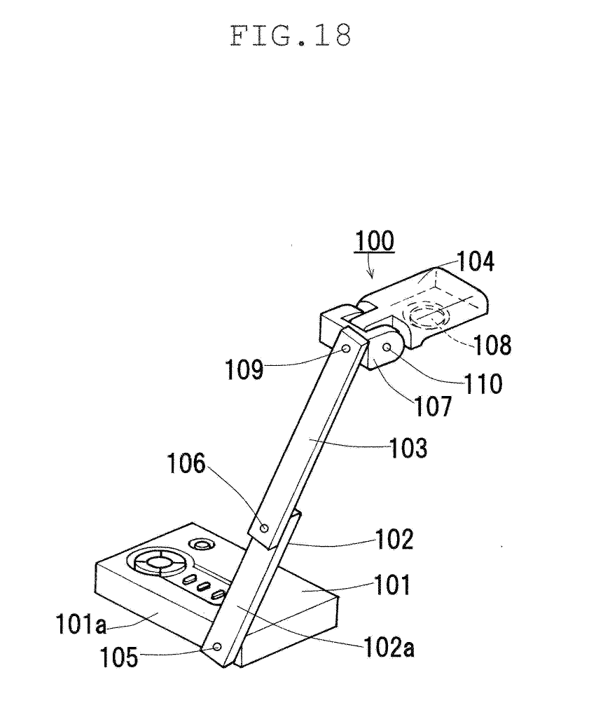

FIG. 19 is a perspective view of the conventional visual presenter, showing column supports and a camera head which have been folded.

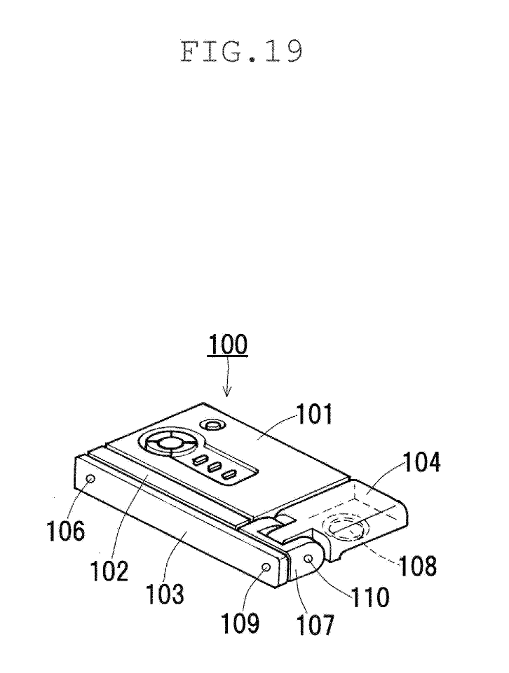

### DETAILED DESCRIPTION

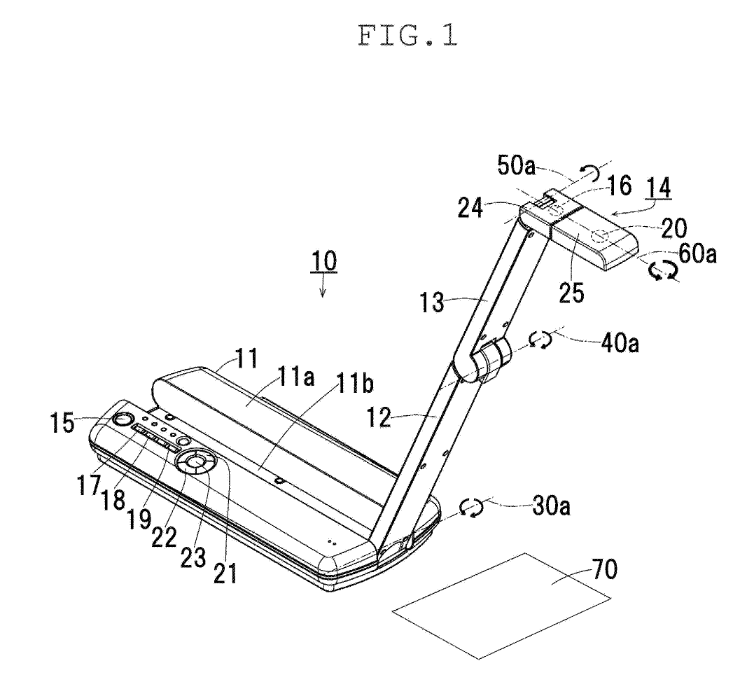

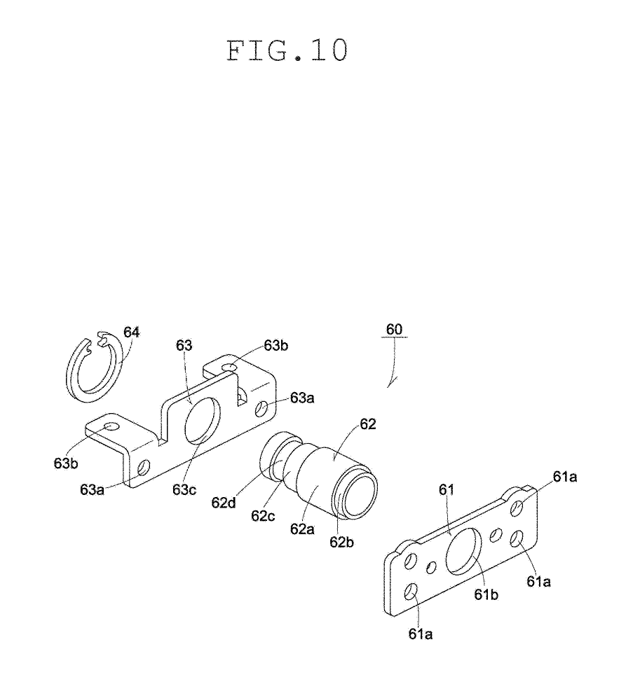

An embodiment will be described with reference to FIGS. 1 to 17. Referring to FIG. 1, a visual presenter 10 according to the embodiment is shown. The visual presenter 10 includes a base 11, a first column support 12 and a second column support 13 and a video camera head 14.

The base 11 is formed into a box shape and has a generally rectangular planar shape. The base 11 includes a top panel 11a having a central part formed with a groove-like accommodation recess 11b which extends in a front-back direction of the base 11. An operation panel 19 is mounted on a rear left half of the top panel 11a. On the operation panel 19 are arranged a power-supply button 15, an illumination switch 17 turning on and off an illumination lamp 16 incorporated in the video camera head 14, a turn button 18 for turning an obtained image and the like. On the operation panel 19 are further arranged zoom buttons 21 and 22 which are operated to actuate an imaging lens 20 of the video camera head 14 so that an image is zoomed, an autofocus button 23 which is operated to perform an autofocus control of the imaging lens 20, and the like. The base 11 includes a rear panel (not shown) on which are mounted terminals for connecting the visual presenter 10 to a TV monitor, a video projector and the like. The base 11 houses a control circuit unit for zoom control of the video camera head 14, autofocus control of the video camera head 14 and luminance control, and counterweight preventing the base 11 from turning over due to the weight of the vide camera head 14.

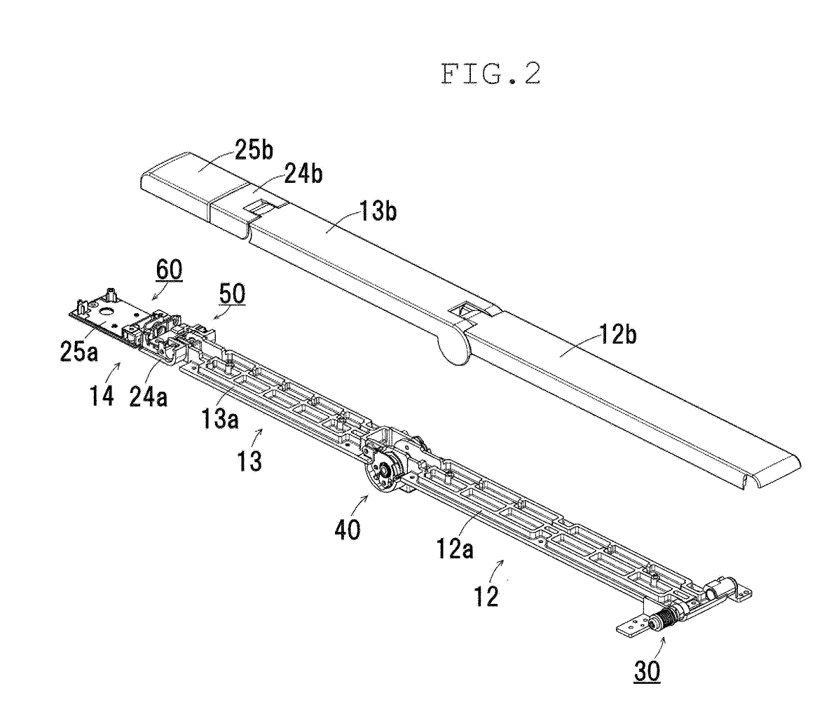

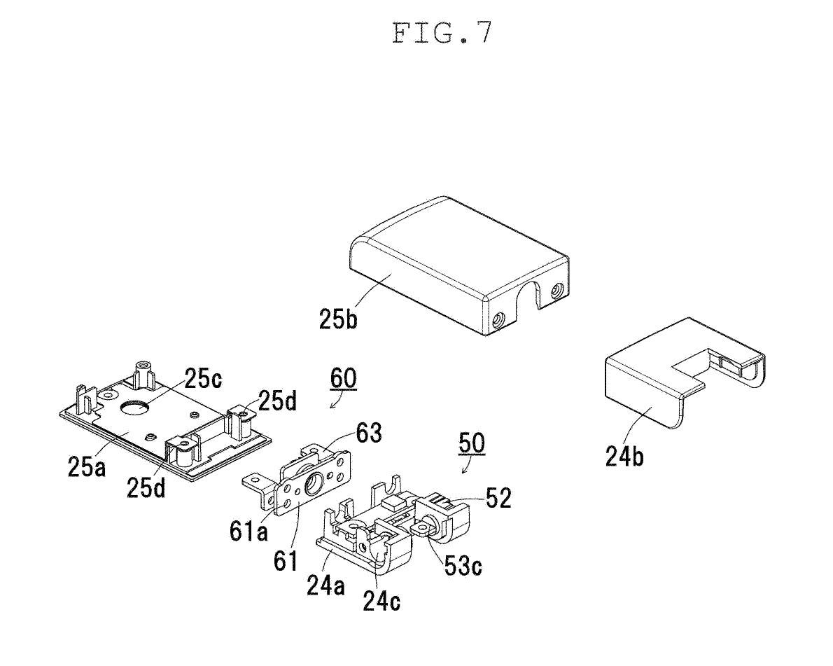

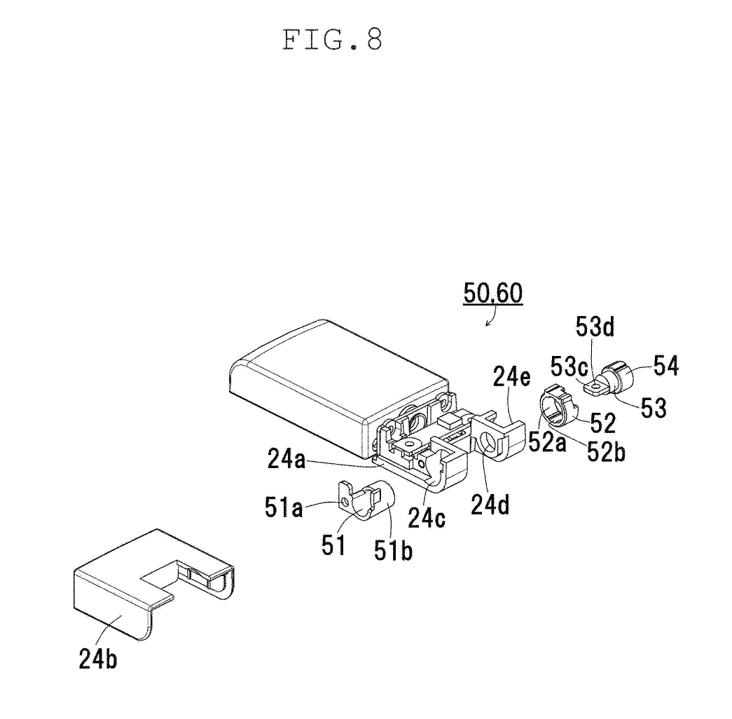

The first column support 12 includes a lower frame 12a and an upper cover 12b as shown in FIG. 2. The first column support 12 has a proximal end which is mounted on a first shaft support construction 30 further mounted on a front end of the accommodation recess 11a so that the first column support 12 is pivotable in the front-back direction about a shaft center 30a. The second column support 13 also includes a lower frame 13a and an upper cover 13b. The second column support 13 has a proximal end which is mounted on a second shaft support construction 40 further mounted on a distal end of the first column support 12 so that the second column support 13 is pivotable in the front-back direction about a shaft center 40a. The video camera head 14 includes a camera base 24 and a lens unit 25. The lens unit 25 includes an imaging lens 20 disposed on the underside of the lens unit 25. As shown in FIG. 7 the camera base 24 includes a lower frame 24a and an upper cover 24b. The lens unit 25 also includes a lower frame 25a and an upper cover 25b. The camera base 24 is mounted on a third shaft support construction 50 further mounted on a distal end of the second column support 13 so that the camera base 24 is pivotable in the front-back direction about a shaft center 50a as shown in FIG. 8. Furthermore, the lens unit 25 is mounted on a fourth shaft support construction 60 further mounted on the camera base 24 so that the lens unit 25 is pivotable in the right-left direction about a shaft center 60a.

Each of the first and second column supports 12 and 13 has a hollow structure. Wiring connecting between the control circuit unit in the base 11 and the video camera head 14 is inserted through the first and second column supports 12 and 13. The first and second column supports 12 and 13 and the video camera head 14 have respective widths that are set so that the first and second column supports 12 and 13 and the video camera head 14 are each allowed to be accommodated in the accommodation recess 11b. The first and second column supports 12 and 13 and the video camera head 14 further have respective thicknesses that are set so that the first and second column supports 12 and 13 and the video camera head 14 are allowed to be accommodated in the accommodation recess 11b in a stacked state.

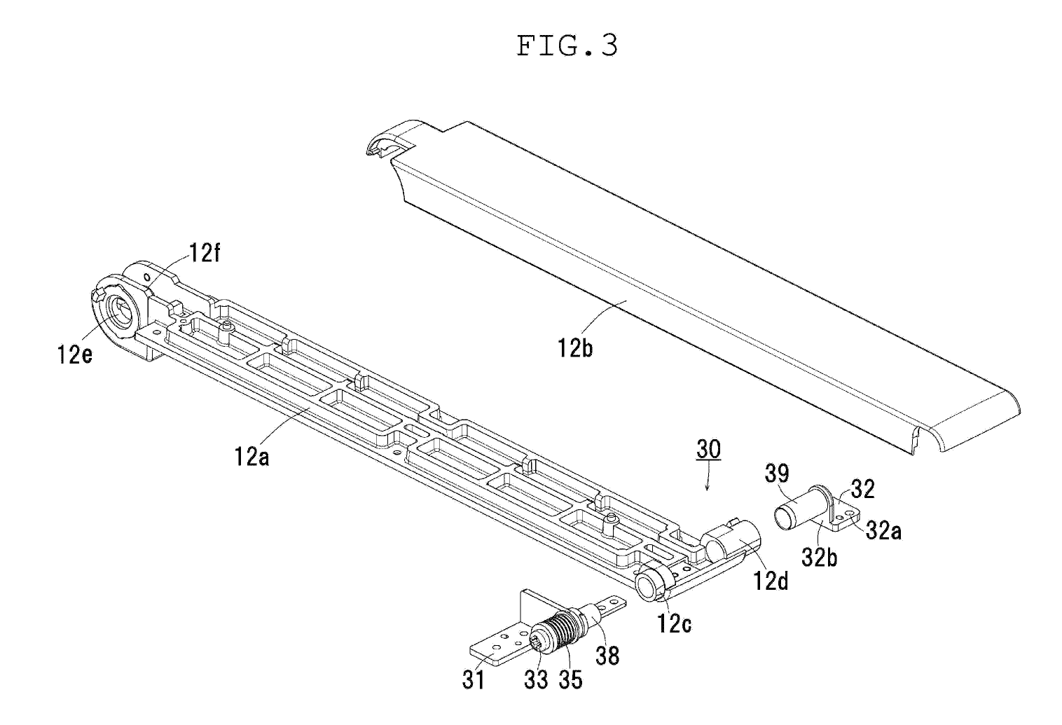

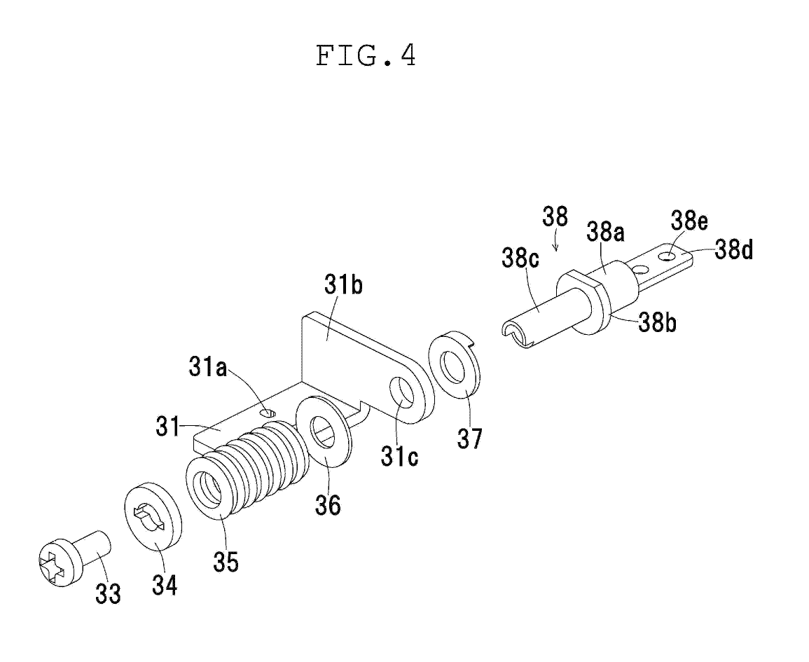

The first shaft support construction 30 includes a left bracket 31, a right bracket 32, a bolt 33, a presser plate 34, a disc spring 35, washers 36 and 37 and a shaft member 38 as shown in FIGS. 3 and 4. On the other hand, the lower frame 12a of the first column support 12 has a proximal end formed with a right cylindrical shaft 12d and a left cylindrical shaft 12c.

The shaft member 38 includes a shaft portion 38a, which has one end formed integrally with a flange 38b and a cylindrical portion 38c and the other end formed integrally with a stay 38d, as shown in FIG. 4. The cylindrical portion 38c has an inner periphery formed with a thread groove (not shown). The stay 38d has through holes 38e.

The left bracket 31 has a through hole 31a. The left bracket 31 has one end formed integrally with a right-angled bent portion 31b, which has a through hole 31c.

The cylindrical portion 38c of the shaft member 38 is inserted through the hole 31c of the right-angled bent portion 31b of the left bracket 31 with a washer 37 being interposed therebetween. The washer 36, the disc spring 35 and the presser plate 34 are attached to the cylindrical portion 38c. The bolt is threadingly engaged with the thread groove of the cylindrical portion 38c so that the left bracket 31 and the shaft member 38 are assembled integrally with each other.

The left bracket 31 is fixed near the left side surface of the front end of the accommodation recess 11b of the base 11 with a small screw (not shown) put into the hole 31a. The shaft portion 38a of the shaft member 38 is inserted through the left cylindrical shaft 12c and small screws (not shown) are put into the respective holes 38e, whereby the shaft member 38 is fixed to the proximal end of the lower frame 12a.

The right bracket 32 is formed with through holes 32a and has one end formed integrally with a right-angled bent portion 32b, to which a shaft portion 39 is fixed. The shaft portion 39 is inserted through the right cylindrical shaft 12d of the lower frame 12a, and small screws (not shown) are put through the respective holes 32a, whereby the right bracket 32 is fixed near the front-end right side of the base 11.

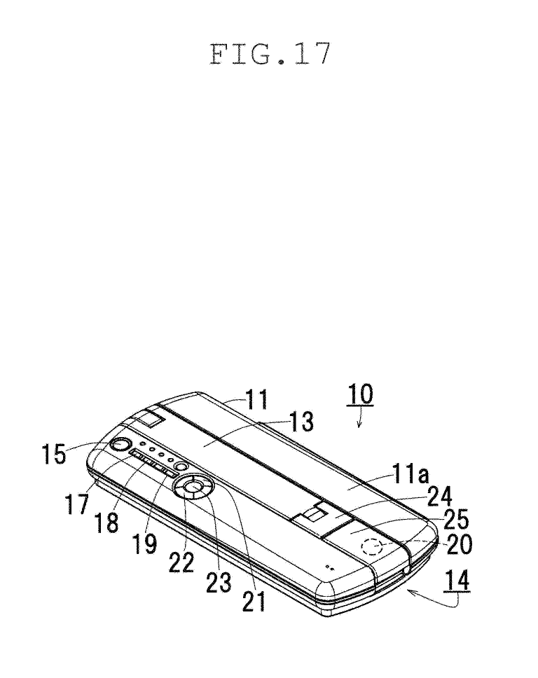

In the first shaft support construction 30 with the above-described structure, the first column support 12 is mounted on the base 11 so as to be pivotable about the shaft center 30a of a first shaft constituted by the shaft portions 38a and 39 between an accommodation position where the rear of the first column support 12 lies in the accommodation recess 11b as shown in FIG. 17 and a use position where the first column support 12 is leaned from the front end of the base 11 at a predetermined rising angle as shown in FIG. 1. A pivoting angle of the first column support 12 is set in an angular range of 150° in the embodiment. The first column support 12 is further retained at any rising angle within an angular range of 150° by a friction damping force produced between the washer 36 biased by the disc spring 35 and the right-angled bent portion 31b of the left bracket 31.

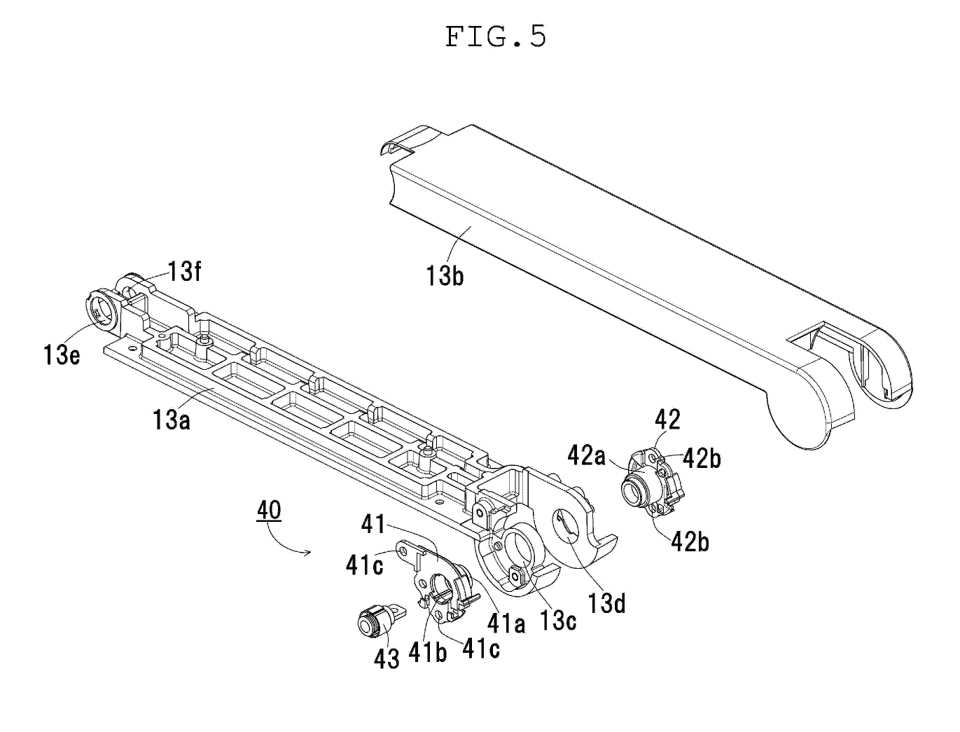

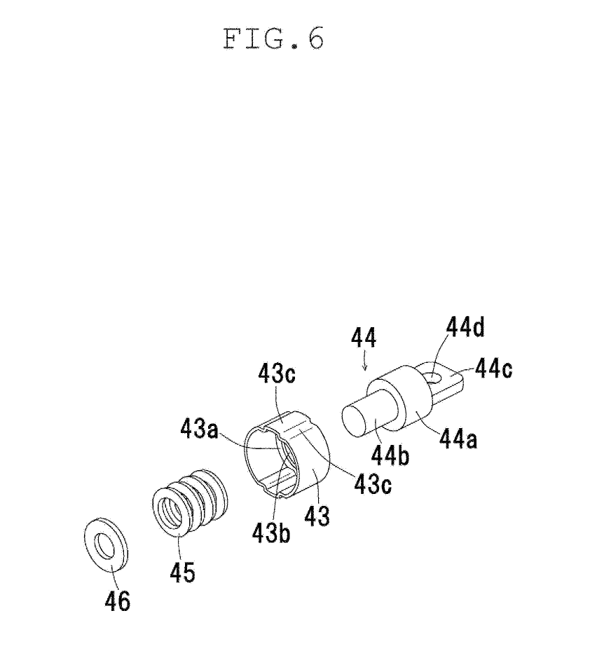

The second shaft support construction 40 includes a left bracket 41, a right bracket 42, a sleeve 43, a shaft member 44, a disc spring 45 and a swage ring 46 as shown in FIGS. 5 and 6. The lower frame 13a of the second column support 13 has a proximal end formed with a right shaft hole 13d and a left shaft hole 13c. On the other hand, the lower frame 12a of the first column support 12 has a distal end formed with a right shaft hole 12f and a left shaft hole 12e.

The left bracket 41 includes a cylindrical portion 41a formed integrally therewith and having an inner periphery formed with grooves 41b. The left bracket 41 is further formed with a through hole 41c. The right bracket 42 includes a cylindrical shaft 42a formed integrally therewith and a through hole 42b formed therethrough.

The first column support 12 has right and left shaft holes 12f and 12e formed in the distal end thereof, and the second column support 13 has right and left shaft holes 13d and 13c formed in the proximal end thereof, as shown in FIG. 3 and FIG. 5. The first and second column supports 12 and 13 are overlapped so that the shaft holes 12f, 12e, 13d and 13c are aligned with one another. The cylindrical portion 41a of the left bracket 41 is inserted through the shaft holes 13c of the lower frame 13 and the shaft hole 12e of the lower frame 12a, and a small screw (not shown) is put through the hole 41c of the left bracket 41, so that the left bracket 41 is fixed to the proximal end of the second column support 13. Furthermore, the cylindrical shaft 42a of the right bracket 42 is inserted through the shaft hole 13d of the lower frame 13a and the shaft hole 12f of the lower frame 12a, and a small screw (not shown) is put through the hole 42b of the right bracket 42, so that the right bracket 42 is connected to the proximal end of the second column support 13.

The shaft member 44 includes a larger-diameter shaft portion 44a, a smaller-diameter shaft portion 44b protruding from one end of the larger-diameter shaft portion 44a and a stay 44c protruding from the other end of the larger-diameter portion 44a, as shown in FIG. 6. The stay 44c has a through hole 44d.

The sleeve 43 has one end formed with a flange 43a having a though hole 43b. The sleeve 43 has an outer periphery formed with convex portions 43c. The smaller-diameter portion 44b of the shaft member 44 is inserted through the hole 43b of the sleeve 43, and the disc spring 45 is then attached to the smaller-diameter portion 44b which has been inserted through the hole 43b. The smaller-diameter shaft portion 44b is retained by the swage ring 46.

When the sleeve 43 to which the shaft member 44 has been attached is inserted into the cylindrical portion 41a of the left bracket 41, the grooves 41b of the cylindrical portion 41a and the convex portions 43c of the sleeve 43 are engaged with each other, thereby being connected together, respectively. Furthermore, small screws (not shown) are put through the holes 44d of the stay 44c so that the shaft member 44 is fixed to the first column support 12.

In the second shaft support construction 40 with the above-described structure, the second column support 13 is mounted on the distal end of the first column support 12 so as to be pivotable by 180° about the shaft center 40a of a second shaft (not shown) constituted by the shaft portion 44 between a use position where the second column support 13 extends in the same direction as the first column support 12 as shown in FIG. 1 and an accommodation position where the second column support 13 lies over the first column support 12 as shown in FIG. 17. The flange 43b of the sleeve 43 is biased by the disc spring 45 thereby to be pressed against the end surface of the larger-diameter portion 44a of the shaft member 44, whereupon the second column support 13 is retained at any pivot angle within an angular range of 180° by a friction damping force produced between the flange 43b and the end surface of the larger-diameter shaft portion 44a.

The third shaft support construction 50 includes a left bracket 51, a right bracket 52, a shaft member 53, a sleeve 54, a disc spring 55 and a swage ring 56, as shown in FIGS. 7, 8 and 9. On the other hand, the distal end of the second column support 13 is formed with a right shaft hole 13f and a left shaft hole 13e. The lower frame 24a of the camera base 24 is formed with a right shaft hole 24d and a left shaft hole 24c. A fit recess 24e is formed in the outside of the right shaft hole 24d. The left bracket 51 is formed with a through hole 51a and includes a cylindrical portion 51b formed integrally therewith. The right bracket 52 has a shaft hole 52a, which has an inner periphery formed with grooves 52b.

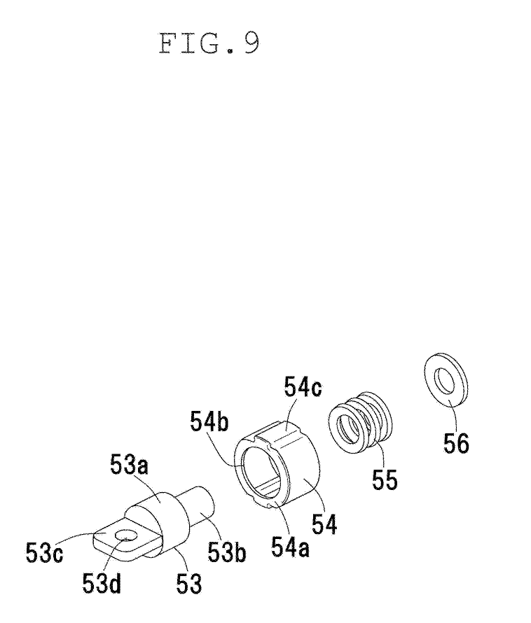

The shaft member 53 includes a larger-diameter shaft portion 53a, a smaller-diameter cylindrical portion 53b and a stay 53c formed integrally with one another as shown in FIG. 9. The stay 53c has a through hole 53d formed therethrough. The sleeve 54 has one end formed with a flange 54a, which has a through hole 54b. The sleeve 54 has an outer periphery formed with convex portions 54c. The smaller-diameter shaft portion 53b of the shaft member 53 is inserted through the hole 54b of the sleeve 5. The disc spring 55 is attached to the smaller-diameter cylindrical portion 53b and is retained by the swage ring 56.

The left shaft hole 24c formed through the lower frame 24a of the camera base 24 and the left shaft hole 13e formed through the distal end of the second column support 13 are overlapped, and the right shaft hole 24d of the lower frame 24 and the right shaft hole 13f formed through the distal end of the second column support 13 are overlapped, as shown in FIG. 2. The cylindrical portion 51b of the left bracket 51 is inserted through the left shaft hole 24c formed through lower frame 24a of the camera base 24 and the left shaft hole 13e of the second column support 13. A small screw (not shown) is then put through the hole 51a, so that the left bracket 51 is fixed to the lower frame 24a.

The right bracket 52 is fitted in the fit recess 24c of the lower frame 24a. The stay 53c of the shaft member 53 is inserted through the shaft hole 52a of the right bracket 52, protruding from the right shaft hole 24d of the lower frame 24a. A small screw (not shown) is put through the hole 53d so that the stay 53c is fixed to the second column support 13. Furthermore, the sleeve 54 is attached to the shaft hole 52a of the right bracket 52, and the convex portions 54c are fitted into the respective grooves 52b of the right bracket 52, so that the sleeve 54 and the right bracket 52 are coupled together.

In the third shaft support construction 50 with the above-described structure, the camera base 24 is mounted on the distal end of the second column support 13 so as to be pivotable about the shaft center 50a of a third shaft constituted by the larger-diameter shaft portion 53a, rearward from the position as shown in FIG. 1 within an angular range of 180°. Furthermore, the flange 54a of the sleeve 54 biased by the disc spring 55 presses the end surface of the larger-diameter shaft portion 53a, whereupon the camera base 24 is retained at any pivot angle within an angular range of 180° by a friction damping force produced between the flange 54a and the end surface of the larger-diameter shaft portion 53a.

The fourth shaft support construction 60 includes a front bracket 61, a cylindrical shaft 62, a rear bracket 63 and a C-shaped ring 64. The lower frame 25a of the lens unit 25 is formed with a lens hole 25c and a screw hole 25d as shown in FIGS. 7, 8 and 10. The front bracket 61 has through holes 61a and a shaft hole 61b all formed therethrough. Small screws (not shown) are inserted through the holes 61a so that the front bracket 61 is fixed to the lower frame 24a of the camera base 24. The cylindrical shaft 62 includes a larger-diameter shaft portion 62a, a smaller-diameter shaft portion 62b and another smaller-diameter shaft portion 62c. The smaller-diameter shaft portion 62c is formed with a ring groove 62d. The smaller-diameter shaft portion 62b is fitted into the shaft hole 61b so that the cylindrical shaft 62 is fixed to the front bracket 61.

The rear bracket 63 has two through holes 63a, two through holes 63b and a shaft hole 63c. The smaller-diameter shaft portion 62c of the cylindrical shaft 62 is rotatably inserted through the shaft hole 63c of the rear bracket 63. The C-shaped ring 64 is fitted in the ring groove 62d thereby to retain the cylindrical shaft 62 relative to the rear bracket 63. The larger-diameter shaft portion 62a of the cylindrical shaft 62 has an end surface pressed against the rear bracket 63. Small screws (not shown) are screwed through the holes 63b into the screw holes 25d of the lower frame 25a so that the rear bracket 63 is fixed to the lower frame 25a, respectively.

In the fourth shaft support construction 60 with the above-described structure, the lens unit 25 is mounted on the cylindrical shaft 62 further mounted on the camera base 24 so that the lens unit 25 is pivotable about the shaft center 60a of the fourth shaft constituted by the cylindrical shaft 62 in an angular range of 180° in the clockwise direction and in an angular range of 120° in the counterclockwise direction. Furthermore, the lens unit 25 is retained at any pivot angle within a predetermined range of pivotal movement by a friction damping force produced by pressing the end surface of the larger-diameter shaft portion 62a of the cylindrical shaft 62 against the rear bracket 63.

When a material 40 is imaged by the visual presenter 10 constructed as described above, the base 11 is installed on the installation surface and connected by a connecting cord to a TV monitor or a projector although none of them are shown.

FIG. 1 shows a first manner of use that is a basic one in the case where a material 70 placed on the base installation surface in front of the base 11. In the first manner of use, the first column support 12 is caused to pivot 120° from the accommodation recess 11b so as to rise. The first column support 12 is set at a use position where the first column support 12 is leaned from the base 11. The second column support 13 is set at a use position where the second column support 13 extends in the same direction as the first column support 12. The video camera head 14 is set at a use position where the video camera head 14 is folded substantially at right angles from the distal end of the second column support 13 so that the lens unit 25 projects forward. In the first use mode, the video camera head 14 can image the material 70 placed on the base installation surface in front of the base 11.

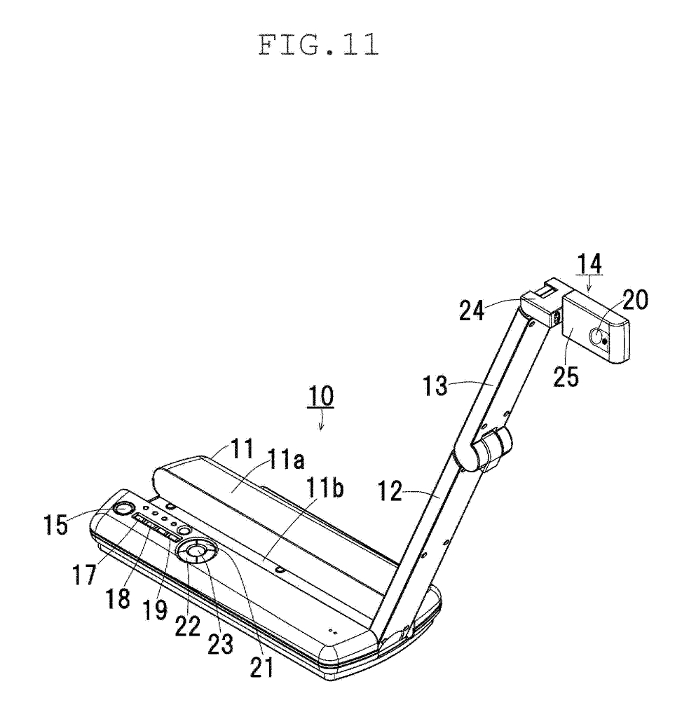

FIG. 11 shows a second manner of use of the visual presenter 10. In the second use manner, the lens unit 25 of the camera head 14 in the first use manner is caused to pivot about 90° leftward. According to the second use mode, the video camera head 14 can image landscape or a person on the left of the base 11.

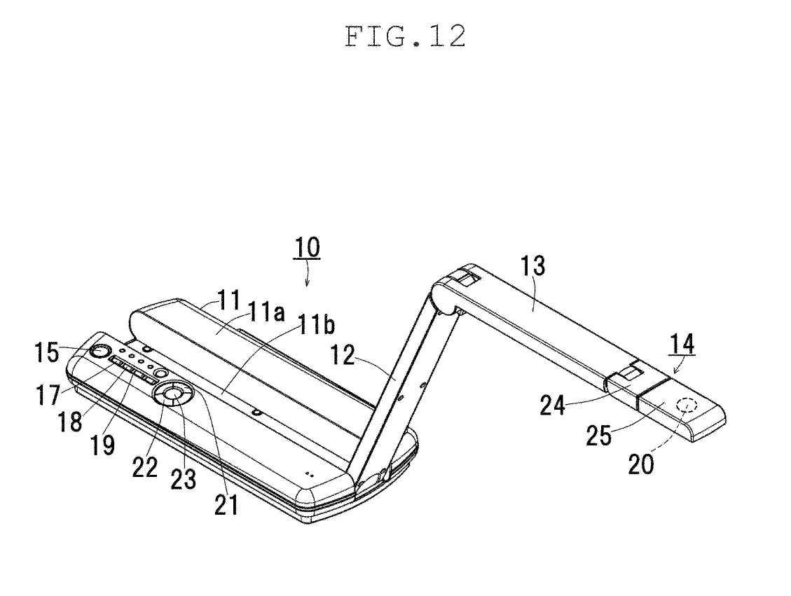

FIG. 12 shows a third manner of use of the visual presenter 10. In the third use manner, the second column support 13 in the first use manner is caused to pivot forward about 60° and the video camera head 14 in the first use manner is caused to pivot rearward about 60°. The video camera head 14 is extended in the same direction as the second column support 13 from the distal end of the second column support 13. According to the third use mode, the video camera head 14 can image the material 70 placed farther frontward than the material 70 imaged in the first use manner.

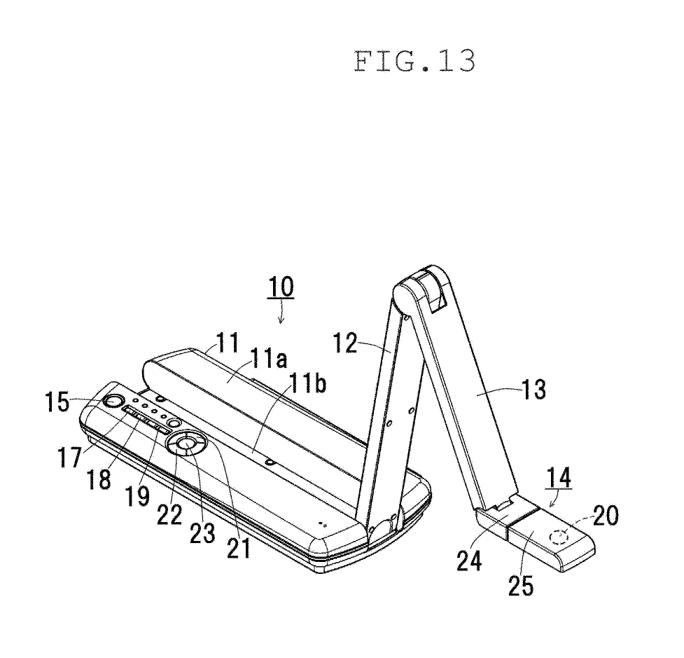

FIG. 13 shows a fourth manner of use of the visual presenter 10. In the fourth use manner, the second column support 13 in the first use manner is caused to pivot forward about 150° and the video camera head 14 in the first use manner is caused to pivot rearward about 60°. According to the fourth use manner, the imaging lens 20 can be located nearer the material placed on the base installation surface in front of the base 11 than in the first use manner.

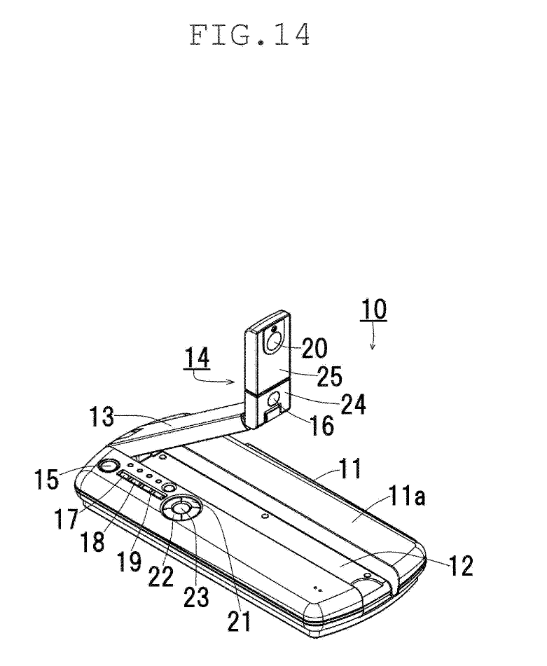

FIG. 14 shows a fifth manner of use of the visual presenter 10. In the fifth use manner, the first column support 12 in the first use manner is laid into the accommodation recess 11b, and the second column support 13 in the first use manner is caused to pivot forward about 120°. The video camera head 14 in the first use mode is caused to pivot rearward about 120°. According to the fifth use manner, the video camera head 14 can image landscape or a person in front of the base 11. Furthermore, since the first and second column supports 12 and 13 and the video camera head 14 are prevented from protruding out of the base 11, a space necessary to install the visual presenter 10 can be rendered smaller.

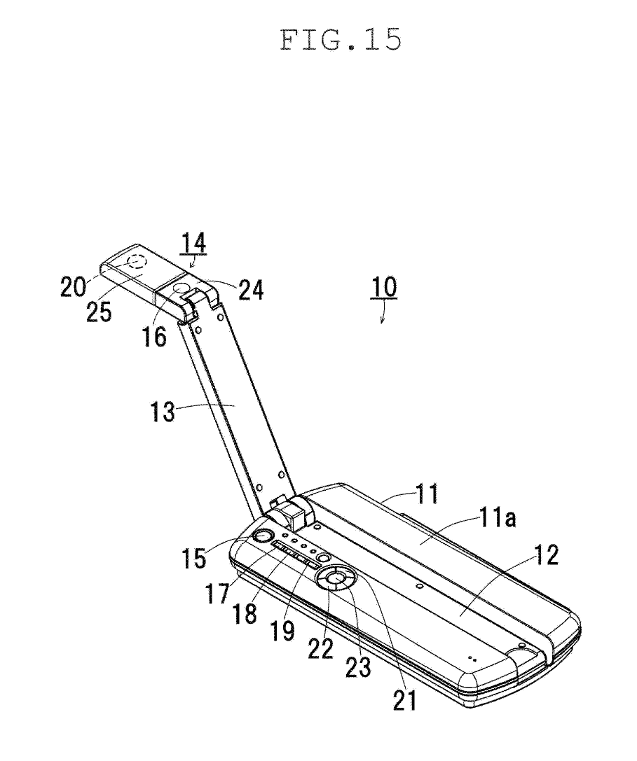

FIG. 15 shows a sixth manner of use of the visual presenter. In the sixth use manner, the first column support 12 in the first use manner is laid into the accommodation recess 11b of the base 11, and the second column support 13 in the first use manner is caused to pivot forward about 60°. The video camera head 14 in the first use manner is caused to pivot rearward about 120°, and the lens unit 25 is caused to pivot 180°. According to the sixth use manner, the visual presenter 10 can image the material placed on the base installation surface on the rear of the base 11.

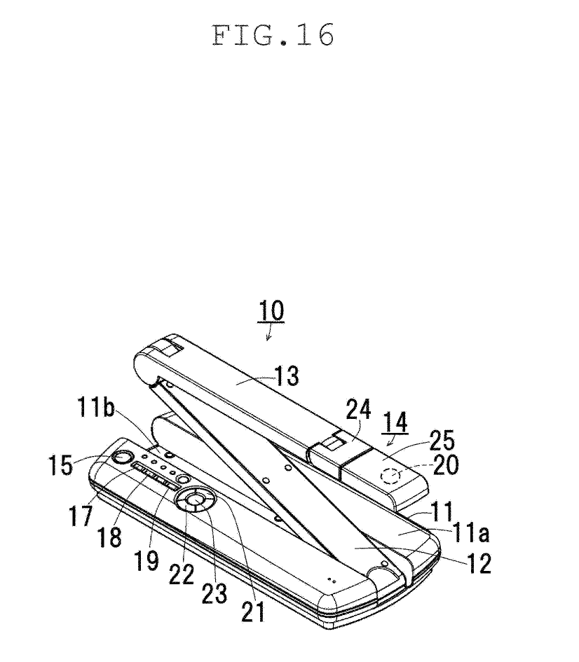

FIG. 16 shows the visual presenter 10 which is being folded. FIG. 17 shows the visual presenter 10 which has been folded. In folding the visual presenter 10, the first column support 12 is laid into the accommodation recess 11b of the base 11. The second column support 13 and the video camera head 14 are then laid onto the front surface of the first column support 12. The first and second column supports 12 and 13 and the video camera head 14 have respective thicknesses that are set so that the upper surfaces of the second column support 13 and the video camera head 14 become substantially coplanar with the top panel 11a of the base 11 when the visual presenter 10 has been folded as shown in FIG. 16. Furthermore, the first and second column supports 12 and 13 and the video camera head 14 have respective lengths that are set so that the first and second column supports 12 and 13 and the video camera head 14 are prevented from protruding from the front and rear end surfaces of the base 11 when the visual presenter 10 has been folded as shown in FIG. 17.

According to the above-described embodiment, the video camera head 14 can image landscape or a person located in front, in the rear, on the right and on the left of the base 11 as well as the material placed on the base installation surface in front and in the rear of the base 11.

Furthermore, the first and second column supports 12 and 13 and the video camera head 14 can be retracted into the accommodation recess 11b formed in the central upper surface of the base 11. Since the first and second column supports 12 and 13 and the video camera head 14 are prevented from protruding from the base 11, the visual presenter 10 can be folded compactly.

The first column support 12 is mounted on the front end of accommodation recess 11b formed in the central part of the base 11. Consequently, when the first column support 12 has been raised, the load of the first and second column supports 12 and 13 and the video camera head 14 can be prevented from being disproportionately applied to a right or left half of the base 11. Furthermore, the first shaft 30a on which the first column support 12 is mounted is further mounted so as to extend between both side surfaces of the accommodation recess 11b. Consequently, the first column support 12 can stably be raised. This can prevent swing of the obtained image due to instability of the raised first column support 12.

The foregoing description and drawings are merely illustrative and are not to be construed in a limiting sense. Various changes and modifications will become apparent to those of ordinary skill in the art. All such changes and modifications are seen to fall within the scope as defined by the appended claims.

What is claimed is:

1. A visual presenter comprising:
a base;
a column support which stands on the base so as to be pivotable; and
a video camera head mounted on a distal end of the column support, the video camera head being located substantially right above a material placed on a base installation surface so that the material is imaged by the video camera head, wherein:
the column support includes a first column support and a second column support;
the base has an upper surface formed with an accommodation recess which is located substantially at a central part of the upper surface and extends in a front-back direction of the base;
the accommodation recess has a front end with two side surfaces between which a first shaft is disposed, the first shaft having two ends fixed to the base;
the first column support is mounted on the first shaft so as to be pivotable in the front-back direction between an accommodation position where the first column support lies in the accommodation recess and a use position where the first column support is raised from the accommodation recess to be leaned forward from a front surface of the base;
the second column support has a proximal end mounted on a second shaft further mounted on a distal end of the first column support so that the second column support is pivotable in the front-back direction between an accommodation position where the second column support lies along a front of the first column support and a use position where the second column support extends from the first column support;
the video camera head is mounted on a third shaft further mounted on a distal end of the second column support so that the video camera head is pivotable in the front-back direction between an accommodation position where the video camera head extends in the same direction as the second column support and a use position where the lens projects forward from the distal end of the second column support;
when the first and second column supports and the camera head are in the respective accommodation positions, the second column support and the video camera head are configured to lie along the front surface of the first column support; the first and second column supports and the video camera head are configured to be accommodated in the accommodation recess; and
the second column support and the video camera head have respective upper surfaces that are substantially co-planar with an upper surface of the base.

2. The visual presenter according to claim 1, wherein:
the video camera head is divided into a camera base and a lens; and
the camera base is mounted on the third shaft further mounted on the distal end of the second column support, the visual presenter further comprising:
a fourth shaft on which the lens is mounted and which is further mounted on the camera base so that the lens is pivotable in a right-left direction;
a first retaining unit provided on the first shaft to retain the first column support at any pivot angle within a predetermined range relative to the base;
a second retaining unit provided on the second shaft to retain the second column support at any pivot angle within a predetermined range relative to the first column support;
a third retaining unit provided on the third shaft to retain the video camera head at any pivot angle within a predetermined range relative to the second column support; and
a fourth retaining unit provided on the fourth shaft to retain the lens at any pivot angle within a predetermined range relative to the camera base.
